(19) United States
(12) Patent Application Publication
(10) Pub. No.: US 2003/0101683 A1
(43) Pub. Date: Jun. 5, 2003

(54) Evacuated panel for thermal insulation of cylindrical bodies

(75) Inventor: Pierattilio Di Gregorio, Sulmona (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: SAES Getters S.p.A.

(21) Appl. No.: 10/331,887

(22) Filed: Dec. 30, 2002

Related U.S. Application Data
(63) Continuation of application No. PCT/IT01/00338, filed on Jun. 27, 2001.

(30) Foreign Application Priority Data
Jun. 30, 2000 (IT) MI2000A 001488

(51) Int. Cl. F16L 9/14; E04C 2/34

(52) U.S. Cl. 52/794.1; 138/149

(57) ABSTRACT

An evacuated panel (2) is provided which enables the thermal insulation of a cylindrical body (1) having two substantially rectangular main faces, formed of a flexible envelope (4) made of one or more barrier sheets, and containing a discontinuous or porous, inorganic or polymeric filling material (3). The panel has a thickness such that the ratio between this thickness and the minimum bending radius of the lateral wall of the cylindrical body is small enough so as to enable the winding of the panel without compromising the integrity thereof, and a length such that it allows at least two windings around the body (1).

### CROSS-REFERENCE TO RELATED APPLICATIONS

This application is a continuation of International Application No. PCT/IT01/00338, filed Jun. 27, 2001, which was published in the English language on Jan. 10, 2002, under International Publication No. WO 02/02986 A1 and the disclosure of which is incorporated herein by reference.

### BACKGROUND OF THE INVENTION

The present invention relates to an evacuated panel which enables the thermal insulation of a substantially cylindrical body to be obtained.

Evacuated panels, and particularly those made with plastic materials, are being increasingly used in all fields where thermal insulation at temperatures lower than about 100° C. is required. As examples of such applications can be mentioned the walls of domestic and industrial refrigerators, of drink dispensing machines (wherein thermal insulation is required, above all, in order to separate the portion for hot drinks, generally at about 70° C., from that for cold drinks), or of containers for isothermal transportation, for instance of cold or frozen drugs or food. Further, applications of these panels in the building field or in the car industry are being studied.

As is known, an evacuated panel is formed of an envelope, having generally a thickness of some tens or hundreds of micrometers, wherein a filling material having a thickness between some millimeters and some centimeters is provided.

The heat transport between the two faces of the panel is due to the sum of four main phenomena, namely conduction in the filling material; convection due to the presence of gas traces in the panel; radiative transport inside the panel; and finally conduction in the sheet or sheets which form the envelope, known in the field as “skin effect”, possibly through the thermal bridge which is formed at the edge of the panel at the welding zones of the sheets.

The envelope has the function of preventing (or reducing as much as possible) the entry of atmospheric gases into the panel, so as to reduce the contribution of convection to the total heat transport. For this purpose, the envelope is made with so-called “barrier” sheets, characterized by having gas permeability as low as possible, which can be formed of a single component but more frequently are multi-layers of different components. In the case of multi-layers, the barrier effect is conferred by one of the component layers, whereas the other layers generally have functions of mechanical support and protection of the barrier layer. The most potent barrier effect is obtained by inserting a metal sheet (generally aluminum having a thickness of about 4-10 μm) between two or more sheets of plastic material. Since the metals are good heat conductors, the thickness of the aluminum layer is determined by a compromise between the need of maximizing the barrier to gas entry and the need of minimizing skin effect.

The filling material has the function of spacing apart the two opposite faces of the envelope when vacuum is created in the panel. This material can be inorganic, such as silica powder, glass fibers, aerogels, diatomaceous earth, etc., or organic, such as rigid foams of polyurethane or polystyrene, both in the form of boards and of powders. The filling material must in any event be porous or discontinuous, so that the porosities or the interstices can be evacuated. The thickness of the filling material (and therefore of the panel) is determined by the required features of insulation: a better insulation is obviously obtained with higher thickness values of the filling material. Since the permeation of traces of atmospheric gases into the panel is practically unavoidable, these panels contain in most cases also one or more materials (generally referred to as getter materials) capable of sorbing these gases so as to maintain the pressure inside the panel at the desired values.

The known evacuated panels are rigid, and generally have a planar conformation. However, in a number of applications where it would be desirable to use these panels, the surfaces which must be insulated are curved, and mainly cylindrical. In some of these applications the insulating material can be applied externally and in sight, as in the case of piping for transportation of a fluid having a temperature different from room temperature, for example piping for air-conditioning or heating, or for fluid transport in industrial plants. Alternatively, the insulant can be placed inside an interspace, as in the cases of bath heaters, of containers such as Dewar vessels or thermal bottles, or of piping used for oil transportation in arctic regions.

One of the methods used up to now for carrying out the thermal insulation of bodies having non-planar surfaces consists in connecting several plane panels to each other, for example by sticking together the edges thereof by means of a glue, so as to obtain a composite structure which can be bent along the junction lines, so as to adapt it to the shape of the body which must be insulated. This solution is, however, not very satisfying, because the assembly of the panels does not contact closely (with the exception of a few points) the surfaces which must be insulated and, in addition to this, heat transfers take place at the junctions, with the result of a poor efficiency of thermal insulation.

International patent application publication no. WO 96/32605 in the name of the British company ICI describes a method for manufacturing rigid evacuated panels having a non-planar shape. The method consists in making grooves in the filling material (a board of polymeric foam having a thickness equal to that of the desired panel) prior to the evacuating step, the grooves being arranged in the desired direction and having a suitable width and depth. Subsequently, the filling material is inserted into an envelope and the assembly is subjected to the evacuation step. Finally, the evacuated panel is sealed. At the first air exposure, the envelope is forced by the atmospheric pressure to adhere to the surface of the grooves. Due to the tensile forces which are exerted on the envelope, the panels bend along the grooves and take on the final non-planar shape. By means of a series of parallel and rather close grooves, the resulting shape of the panel is nearly cylindrical.

However, this method has a number of drawbacks. First, the thickness of the panel is not regular in all the parts thereof, being thinner at the bending lines, with the result of reduced thermal insulation properties along these bending lines. Second, following the tensile stress exerted at the grooves, breakings, also microscopic, can be created in the envelope and become preferential channels for the permeation of gases toward the inside of the panel, thus permanently compromising the properties of thermal insulation of the panel itself. Further, the shape, size, distances, and mutual positioning of the grooves fixedly determine the final shape of the non-planar panel, so that these panels have to be specially produced for every single application. Finally, the curving of these panels takes place at the first exposure to air, and therefore during the manufacturing process or immediately thereafter. Consequently, as soon as they are manufactured, these panels have a significant overall size, which makes their storage and transport uneconomical.

### BRIEF SUMMARY OF THE INVENTION

Therefore, an object of the present invention is providing an evacuated panel for the thermal insulation of bodies having a cylindrical curved lateral surface, which is free from these drawbacks. The object is achieved by an evacuated panel for thermal insulation of a cylindrical body having a length L, a lateral wall S′ and two bases having a perimeter with a curve C′, the panel being provided with two substantially rectangular main faces and being formed of a flexible envelope made with one or more barrier sheets which contains a discontinuous or porous, inorganic or polymeric filling material, wherein the thickness h of the panel is equal to or less than half the required insulation thickness and is such that the ratio h/r between the thickness of the panel and the minimum bending radius r of the curve C′ is less at every point of the curve than a value depending on the filling material of the panel, and wherein one side of the panel has a length l2 equal to at least twice the length of the curve C′. For example, when the filling material is an open cell polyurethane foam, the ratio h/r is less than about 0.20; when the filling material is an open cell polystyrene foam, the ratio (h/r) is less than about 0.18; and when the filling material is a powder, the ratio h/r is less than about 0.10. Other preferred features of the invention are described in the following.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic diagram of a cylinder according to the broad geometrical definition thereof;

FIG. 2 is a perspective view of a right cylindrical body obtained from FIG. 1, which can be thermally insulated by a panel according to the invention;

FIG. 3 a perspective view, partially broken away, of an evacuated panel according to the present invention in its planar form;

FIG. 4 is a schematic diagram showing a geometrical requirement which has to be met by the panels according to the invention; and

FIGS. 5 and 6 are perspective views showing examples of application of the panels according to the invention.

### DETAILED DESCRIPTION OF THE INVENTION

The panels according to the invention differ from those according to the prior art, because they make up the required total insulating thickness by winding a panel having a small thickness at least twice around the body to be insulated.

This new configuration brings about a number of advantages. First, in a traditional panel the environmental heat is propagated to the external sheet which forms the envelope and, through the edge of the panel, to the envelope sheet in contact with the body which is to be insulated. In contrast, in the panels according to the invention the portion in contact with the environment transmits heat through the envelope to a subsequent layer of the rolled panel. Therefore, the heat must travel a spiral path along the lower face of the panel before reaching the body to be insulated. In this way, the skin effect is largely reduced to negligible values as a contributor of heat conduction between the two faces of the panel.

Further, with the panels according to the invention the insulation thickness is obtained as a multiple of the constant thickness of the panel, thus avoiding the grooves of WO 96/32605, which represent zones having a reduced thickness and therefore higher thermal conductivity between the two faces of the panel. Further, with respect to the panels of WO 96/32605, in the evacuated panels according to the present invention the several small creases formed on the internal side of the envelope during the curving cannot, because of their small extent, cause a breaking of the envelope itself and therefore a permeation of atmospheric gases towards the inside of the panel.

Finally, further to these advantages of thermal insulation, the evacuated panels of the present invention are manufactured, stored and transported to the place of final application in planar form, with notable gain of space and costs; each panel is then rolled and fastened around the body to be insulated at the time and place of the effective use.

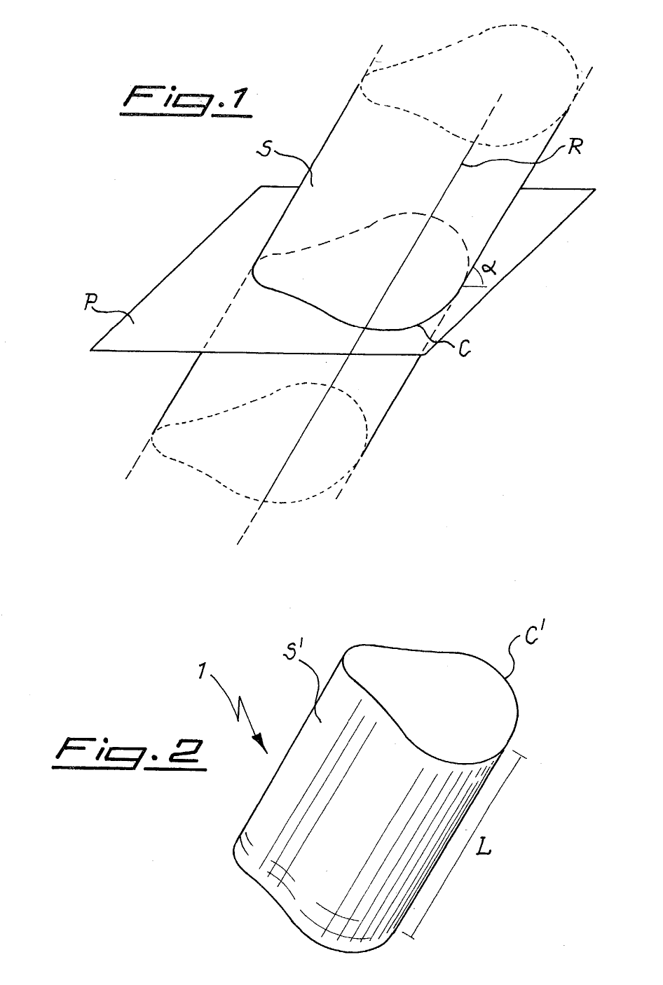

Some geometrical definitions and conditions, relevant for the understanding of the invention, are reported in the following with reference to FIGS. 1 and 2.

The term “cylinder” (and terms derived therefrom) will be used in the present invention in the broadest meaning thereof as shown in FIG. 1. That is, the surface S generated by a straight line R intersecting a plane P at an angle a and by moving the line parallel to itself along a close curved line C lying in the plane P.

FIG. 2 shows a generic solid body 1 which can be thermally insulated by means of a panel according to the present invention: this solid body has a lateral wall S′ which is formed of a portion of the cylindrical surface S of FIG. 1 having length L, and two bases which have the curve C′ as their perimeter; the two bases are defined by the intersection of surface S with two parallel planes, shown in this case perpendicular to straight line R, so that curves C and C′ are equal in the case that angle α is 90°. Body 1 can be solid, but in the common applications of the evacuated panels can be internally empty, for example in the case of a container or piping for fluids.

The most important practical application of the panels according to the invention is for thermally insulating bodies whose lateral wall S′ is a portion of surface S obtained when angle α is equal to 90° and curve C′ is a circumference (constant for cylinders).

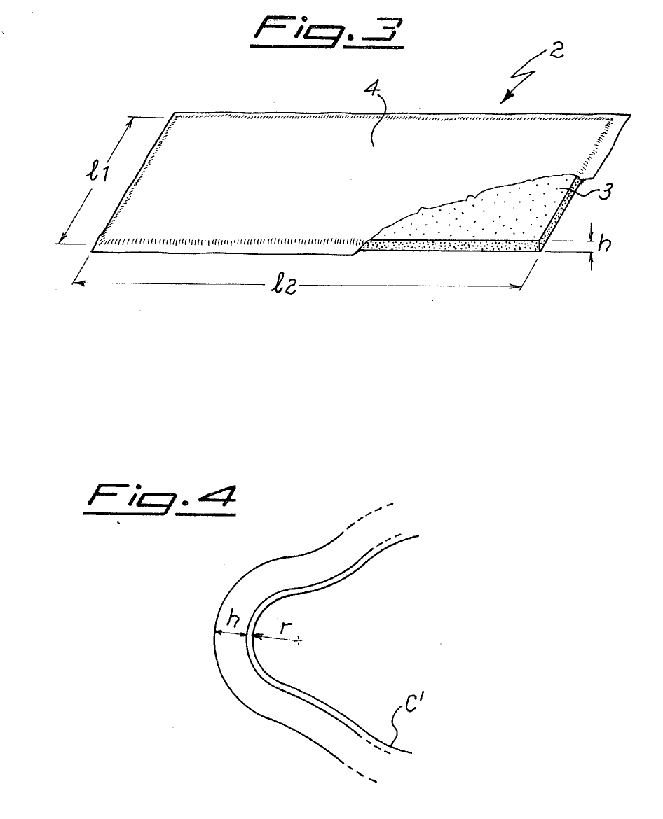

With reference to FIG. 3, evacuated panel 2 according to the present invention is shown, formed in a known way of a filling material 3 closed inside an envelope 4, which may be multi-layer, for example. Panel 2 has the shape of a parallelepiped having a very reduced thickness h and lateral dimensions l1 and l2. The shape can be conferred to the panel by the filling material when it is a board, for example of a polymeric foam. In the case that the filling material does not have its own shape (powders), the panel is shaped during manufacture by introducing the powder in an envelope, evacuating the envelope while it is kept in a suitable die, and finally sealing the open edge of the envelope so as to form the final envelope. The shape conferred by the die is then maintained because of the external pressure exerted through the envelope on the powders, thus keeping them compact. Preferred for the purposes of the invention is the use as filling material of boards of polymeric foams, particularly open cell rigid polyurethane, well known in the field of evacuated panels.

Particularly suitable for the manufacture of envelope 4 are multi-layer sheets, which generally comprise at least one layer, having a relatively large thickness, of a polymeric material provided with good mechanical features, particularly plasticity, which forms the mechanical support for the multi-layer; at least one layer of a material having barrier properties toward atmospheric gases, which can be polymeric or inorganic, preferably a metal and even more preferably aluminum; and at least another polymeric layer, as a covering and mechanical protection for the barrier layer. Multi-layers formed of five, six or even more layers laid one over the other are also common. The manufacture of the envelope starting from these layers is generally made by heat-sealing, by techniques known in the art.

In order to guarantee a longevity of at least fifteen years, the panels according to the invention preferably contain one or more getter materials, that is, materials capable of chemically sorbing moisture and other atmospheric gases. Preferred is the use of getter systems with two or three getter materials, containing at least one chemical for sorbing moisture and at least one component selected among a transition metal oxide (having mainly the function of sorbing hydrogen, CO and hydrocarbons) and an alloy based on barium and lithium (having mainly the function of nitrogen sorption). Various getter systems of this kind are sold by the SAES Getters S.p.A. under the trademark COMBOGETTER®, among which, in particular, are systems containing a moisture sorber and a powder of alloy based on barium and lithium, described in European Patent EP-B-769117; and getter systems containing a moisture sorber and a transition metal oxide, with the optional addition of a powder of alloy based on barium and lithium, described in European published patent application EP-A-757920.

The thickness of the panel h must be such that the panel can be bent without damaging the integrity thereof. This feature depends both on the filling material of the panel and on the intended application. It is generally known that it is possible to elastically deform a planar flexible body, so as to curve it, by applying a force at different points thereof. The force is directly proportional to the cube of the thickness thereof and inversely proportional to the bending radius which is desired, with a proportionality constant different for each material which depends on the mechanical properties thereof. According to this relationship, an increase of the curvature is obtained by applying increasing forces to an initially planar panel having a certain thickness. However, if the panel is subjected to an excessive force, it breaks. The most important parameter in determining the possibility of employing a certain panel in a certain application is the h/r ratio, wherein h is the panel thickness and r is the bending radius of the curve C′ (which forms the cross-section of body 1). With reference to the drawing of FIG. 4, the panel according to the invention must be such that, at every point of the curve C′, the ratio h/r is not higher than a given value for each filling material. It has been found that this maximum value of the ratio h/r is about 0.20 for polyurethane rigid foams, about 0.18 for boards of polystyrene foams and about 0.10 for powder filling materials. As a practical example, a panel having a filling of polyurethane foam to be rolled around a body having a minimum bending radius of about 50 mm can have a maximum thickness of about 10 mm. A board of polyurethane foam having this thickness can be obtained by cutting horizontally, that is, parallel to the main faces thereof, thicker boards which are usually employed for the production of planar panels of the known kind. Alternatively, it is possible to reduce the thickness of the boards by compression, according to a procedure known in the art.

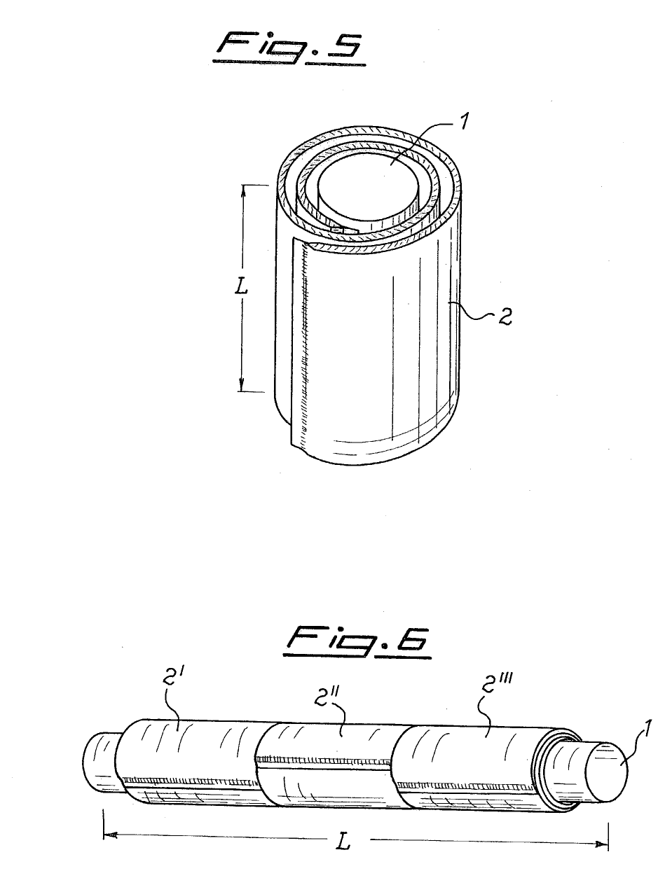

The panel shown in FIG. 4 is suitable for being rolled at least twice around the curved lateral wall S′ of a cylindrical body. Therefore, the two main opposite sides of the panel have the shape of a long rectangle, having sides l1 and l2. One of the dimensions (l2 in the example of FIG. 3) is about double the length of curve C′, so that it is possible to make at least two windings around the body to be insulated. On the other hand, the side l1 is equal to the length L of the body that has to be insulated, or to a sub-multiple thereof. As a matter of fact, as shown in FIG. 5, unless body 1 has an excessive size, the thermal insulation thereof can be made with only one panel 2. Alternatively, as shown in FIG. 6, if the size L is large (for example, if body 1 is a tube), it is preferable to make the body insulation with more panels 2′, 2“, 2′″, . . . placed side by side.

Finally, the panels according to the invention can be placed in sight, for instance in order to insulate piping for civil applications. Alternatively, these panels can be placed inside interspaces, particularly when the difference of temperature to be maitained between the surface S′ and the environment is high. These conditions occur, for example, in the applications of Dewar vessels, in thermal bottles, or in cryogenic piping or piping placed in particularly cold regions, such as the arctic regions. In the case in use of an interspace, the thickness h of the panel, in addition to meeting the above-mentioned requirements, must not be higher than half the thickness of the interspace.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An evacuated panel (2) for thermal insulation of a cylindrical body (1) having a length (L), a lateral wall (S′) and two bases having a perimeter with a curve (C′), the panel comprising a flexible envelope (4) comprising at least one barrier sheet, the envelop having two substantially rectangular main faces and containing a discontinuous or porous, inorganic or polymeric filling material (3), wherein the panel has a thickness (h), the curve (C′) has a minimum bending radius (r), the thickness (h) is no greater than half of a required insulation thickness for the cylindrical body, and the ratio (h/r) at every point of the curve (C′) is less than a value depending on the filling material (3); and wherein one side of the panel has a length (l2) equal to at least twice a length of the curve (C′).

2. The panel according to claim 1, wherein the filling material (3) is an open cell polyurethane foam and the ratio (h/r) is less than about 0.20.

3. The panel according to claim 1, wherein the filling material (3) is an open cell polystyrene foam and the ratio (h/r) is less than about 0.18.

4. The panel according to claim 1, wherein the filling material is a powder and the ratio (h/r) is less than about 0.10.

5. The panel according to claim 1, wherein the curve (C′) is a circumference.

6. The panel according to claim 1, wherein one side of the panel has a length (l1) equal to the length (L) of the body (1).

7. The panel according to claim 1, wherein one side of the panel has a length (l1) equal to a sub-multiple of the length (L) of the body (1).

8. The panel according to claim 1, wherein the envelope (4) at least one multi-layer sheet comprising at least one layer of a polymeric material having good plasticity; at least one layer of a material having barrier properties against atmospheric gases; and at least one heat-sealable polymeric layer.

9. The panel according to claim 8, wherein the barrier layer comprises aluminum having a thickness between 4 and 10 μm.

10. The panel according to claim 1, further containing a getter material or device.

11. The panel according to claim 10, wherein the getter device comprises at least one moisture-sorbing chemical and at least one component selected from the group consisting of a transition metal oxide and an alloy based on barium and lithium.
